(19) United States
(12) Patent Application Publication
(10) Pub. No.: US 2008/0002702 A1
(43) Pub. Date: Jan. 3, 2008

(54) Systems and methods for processing data packets using a multi-core abstraction layer (MCAL)

(75) Inventors: Zeljko Bajic, San Jose, CA (US); Ajay Malik, San Jose, CA (US)

Correspondence Address: INGRASSIA FISHER & LORENZ, P.C., 7150 E. CAMELBACK, STE. 325, SCOTTSDALE, AZ, 85251, US

(73) Assignee: Symbol Technologies, Inc.

(21) Appl. No.: 11/479,686

(22) Filed: Jun. 30, 2006

(51) Int. Cl. H04L 12/56

(52) U.S. Cl. 370/392; 370/401

(57) ABSTRACT

System flexibility and ease-of-design is greatly enhanced by using a multicore abstraction layer (MCAL) to interface between a multicore hardware platform, a device operating system and the packet transfer functions of the system. Systems and techniques are described for processing a data packet received at a network interface of a network infrastructure device (such as a wireless switch) or other computing system, particularly using multi-core processors. A classification handler initially classifies the data packet. A plurality of protocol handlers each associated with a data protocol processes the data packet if the classification of the data packet matches the data protocol associated with the protocol handler, and one of several application handlers each associated with a user applications processes the data packet if the classification of the data packet matches the user application associated with the application handler. The MCAL is configured to send the data packet to the classification handler after the packet is initially received, and to subsequently direct the packet toward one of the protocol or application handlers in response to the classification of the data packet. MCAL further contains a set of the containers for handlers. Real application, protocol and classification handlers register with MCAL and are modules developed outside of the MCAL.

### TECHNICAL FIELD

The present invention generally relates to computing devices, and, more particularly, to processing data packets in computing devices that incorporate single or multiple processing cores.

### BACKGROUND

As digital networks such as the Internet become increasingly commonplace, demand for network infrastructure devices such as bridges, switches, routers and gateways increases. With the advent and rapid adoption of wireless communications (e.g. so-called “Wi-Fi” communications based upon the IEEE 802.11 family of protocols), in particular, the need for wireless network infrastructure products is significant. Wireless switches, for example, are now commonly used to provide access to digital networks (such as the Internet or a corporate/campus network) via various wireless access points. Typically, a wireless switch remains in communication with one or more wireless access points via the network to facilitate wireless communications between the access point and digital network. One example of a wireless switch infrastructure based upon products available from SYMBOL TECHNOLOGIES INC. of San Jose, Calif. is shown in U.S. Patent Publication No. 2005/0058087A1.

Like most conventional computers, network infrastructure devices commonly include a network interface, a processor, digital memory and associated software or firmware instructions that direct the transfer of data from a source to a destination. Because of the cost involved in designing customized hardware, particularly in the case of complex integrated circuitry, most network infrastructure devices have historically been built using commercially-available microprocessor chips, such as those produced and sold by INTEL CORP. of Santa Clara, Calif., FREESCALE SEMICONDUCTOR CORP. of Austin, Tex., AMD CORP. of Sunnyvale, Calif., INTERNATIONAL BUSINESS MACHINES of Armonk, N.Y., and/or RAZA MICROELECTRONICS INC. of Cupertino, Calif., as well as many others.

In more recent years, technological advances in microprocessor and microcontroller circuitry have been significant. As an example, an emerging trend in microprocessor design is the so-called “multi-core” processor, which effectively combines the circuitry of two or more processors onto a common semiconductor die. Many conventional data processing systems that are based upon single processing cores can be limited in throughput in comparison to systems built upon multiple cores. By combining the power of multiple processing cores, however, the speed and efficiency of the computing chip is increased significantly.

With the increasing demands constantly placed upon network infrastructure equipment, particularly in the wireless arena, it would be desirable to take advantage of multi-core processing capabilities. Conventional software, however, is typically not written with such functionality in mind. As a result, there is a need for systems and methods that allow portability of software written for single processor environments to work in a multi-processor setting. Moreover, there is a need for systems and techniques that enable portability between single and multiple processor implementations.

### BRIEF SUMMARY

System flexibility and ease-of-design is greatly enhanced by using a multicore abstraction layer (MCAL) to interface between a single core or multicore hardware platform, a device operating system and the packet transfer functions of the system. According to various embodiments, systems and techniques are provided for processing a data packet received at a network interface of a network infrastructure device (such as a wireless switch) or other computing system, particularly using multi-core processors. A classification handler initially classifies the data packet. A plurality of protocol handlers each associated with a data protocol processes the data packet if the classification of the data packet matches the data protocol associated with the protocol handler, and one of several application handlers each associated with a user applications processes the data packet if the classification of the data packet matches the user application associated with the application handler. The MCAL is configured to send the data packet to the classification handler after the packet is initially received, and to subsequently direct the packet toward one of the protocol or application handlers in response to the classification of the data packet. The MCAL contains a set of the containers for handlers. Real application, protocol and classification handlers register with MCAL and are modules developed outside of the MCAL. See the attached figure with containers;

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 is a block diagram of an exemplary embodiment of an abstracted packet processing system;

FIG. 2 is a block diagram of an exemplary embodiment of an abstracted packet processing system executing across multiple processing cores;

FIG. 3 is a block diagram of a multi-core packet processing system;

FIG. 4 is a block diagram of an exemplary memory allocation scheme; and

FIG. 5 is a flowchart of an exemplary process for processing data packets;

FIG. 6 is a flowchart of an exemplary classification process;

FIG. 7 is a block diagram of an exemplary implementation of a multi-core wireless switch.

### DETAILED DESCRIPTION

The following detailed description is merely illustrative in nature and is not intended to limit the invention or the application and uses of the invention. Furthermore, there is no intention to be bound by any expressed or implied theory presented in the preceding technical field, background, brief summary or the following detailed description.

The invention may be described herein in terms of functional and/or logical block components and various processing steps. It should be appreciated that such block components may be realized by any number of hardware, software, and/or firmware components configured to perform the specified functions.

To enable portability between single core and multi-core systems, a multicore abstraction layer (MCAL) provides a framework that obscures the operating system executed by the system hardware to higher-level program code. Program code uses the MCAL to access system resources and for inter-process communication rather than accessing the operating system directly. By isolating system-specific code into the MCAL, higher level system code can be made more generic, thereby improving portability across single processor, multi-core processor, and/or multi-processor systems. Access to additional hardware (e.g. hardware co-processors) can also be provided through the abstraction layer, thereby further improving software flexibility and ease of design.

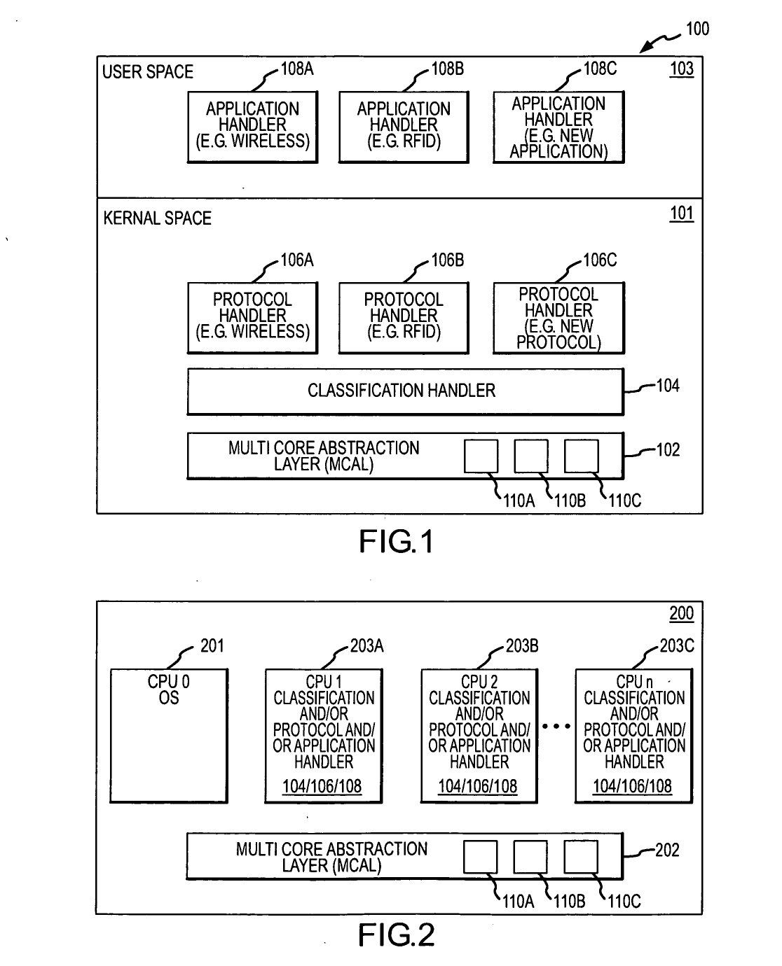

Turning now to the drawing figures and with initial reference now to FIG. 1, an exemplary data processing system 100 suitably includes an abstracted operating system layer 102, a classification handler 104, a protocol handler 106A-C for each communications protocol handled by system 100, and an application handler 108A-C for each control application executing on system 100. Generally speaking, application handlers 108A-C process data relating to control functions, whereas protocol handlers 106A-C manage data simple data transactions. In the exemplary embodiment shown in FIG. 1, system 100 is shown as a wireless switch device capable of routing data packets formatted according to wireless protocols (e.g. IEEE 802.11 or the like) as well as radio frequency identification (RFID) protocols, in addition to any new and/or other protocols that may be desired. The use of wireless and RFID protocols is purely exemplary to illustrate that multiple protocols could be combined into a common system 100. This feature is not necessary in all embodiments, and indeed many equivalent embodiments could be formulated to process any number of wired, wireless or other data communications protocols.

The system 100 shown in FIG. 1 could be implemented within any conventional single-processor general-purpose computing system that executes any suitable operating system. The LINUX operating system, for example, is freely available from a number of commercial and non-commercial sources, and is highly configurable to facilitate the features described herein. Equivalent embodiments could be built upon any version of the MacOS, SOLARIS, UNIX, WINDOWS or other operating systems. Each of these operating systems provide kernel space 101 as well as user space 103 as appropriate. In other embodiments, however, it is not necessary to separate kernel and user space. To the contrary, equivalent embodiments to those described above could be implemented within any sort of operating system framework, including those with “flat” memory architectures that do not differentiate between kernel and user space. In such embodiments, the MCAL 102 and the various handlers would all reside within the flat memory space.

Kernel space 101 as shown in FIG. 1 is any operating system portion capable of providing a multicore abstraction layer (MCAL) 102 to facilitate communication between hardware and software. Kernel 101 also provides software facilities that are provided to applications executing in user space 103 such as process abstractions, interprocess communication and system calls. Again, various equivalent embodiments may not differentiate between kernel space 101 and user space 103, but may nevertheless provide the functionality of MCAL 102 within any convenient memory addressing structure.

As noted above and below, MCAL 102 suitably contains any hardware-specific code for system 100, and provides for communication between the various handlers 104, 106A-C, 108A-C. To that end, MCAL 102 typically includes a set of containers 110A-C for representing various types of data handler modules 104, 106, 108 (described more fully below). Containers 110A-C are any logical structures capable of facilitating inter-process data communications between modules. These communications structures may include, for example, message queues, shared memory, and/or the like. During system configuration and/or startup (or at any other suitable time), handler modules 104, 106, 108 register with MCAL 102. MCAL 102 subsequently provides abstracted version of the system hardware and/or operating system resources to each handler 104, 106, 108 so that the various handlers need not be customized to the particular hardware present in any particular system. That is, handler modules 104, 106, 108 need not be customized or otherwise specially configured for multi-core or multi-processor operation, since such features are abstracted and provided within MCAL 102. In various embodiments, then, the same code used to implement handlers 104, 106, 108 can be run in both single and multi-core environments, with MCAL 102 concealing the hardware specific features from the various handlers. MCAL 102 also initializes hardware components of system 102 as appropriate; such components may include networking interfaces, co-processors (e.g. special processors providing cryptography, compression or other features), and/or the like. MCAL also manages the downloading of handler code to the CPUs, as well as handler starting, stopping, monitoring, and other features. The various functions carried out by MCAL 102 may vary from embodiment to embodiment.

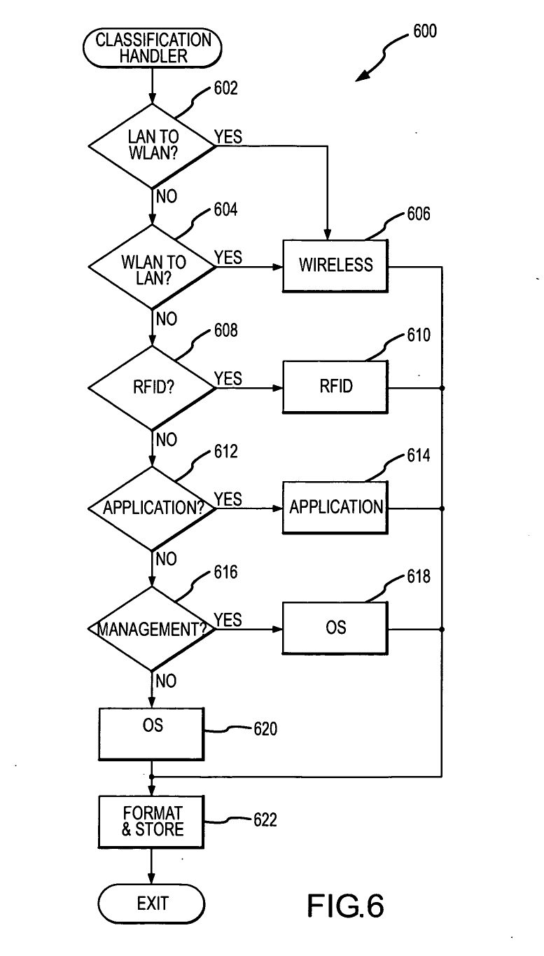

Classification handler (CH) 104 is any hardware, software or other logic capable of recognizing data packets of various protocols and of assigning a classification to the data packet. This classification may identify the particular data type (e.g. wireless, TCP/IP, RFID, etc) based upon header information or other factors, and may further identify a suitable protocol handler 106A-C or application handler 108A-C for processing the data based upon data type, source, destination or any other criteria as appropriate. Classification module 104 therefore acts as a distribution engine, in a sense, that identifies suitable destinations for the various data packets. In various further embodiments, classification handler 104 may further distribute (or initiate distribution) of data packets to the proper handlers using message send constructs provided by MCAL 102, as appropriate. Although FIG. 1 shows only one classification handler 104, alternate embodiments may include two or more classification handlers 104 as desired. Additional detail about an exemplary classification handler 104 is provided below in conjunction with FIG. 6.

Protocol handlers (PH) 106A-C are any software modules, structures or other logic capable of managing the data stack of one or more data communications protocols. An exemplary wireless handler 106A, for example, could terminate Open Systems Interconnect (OSI) layer 2 and/or layer 3 encapsulation (using, e.g., the CAPWAP, WISP or similar protocol) for packets received from wireless access points, and may also terminate 802.11, 802.16, RFID or any other wireless or wired protocols, including any security protocols, to extract data packets that could be transferred on a local area or other wired network. Conversely, wireless handler 106A could initiate encapsulation of data received on the wired network for transmittal to a wireless client via a remote access point, as appropriate. In other embodiments, the send and receive processes could be split into separate protocol handlers 106, as desired.

Application handlers (AH) 108A-C are any software programs, applets, modules or other logic capable of hosting any type of application or control path features of one or more protocols. In the example shown in FIG. 1, wireless application handler 108A processes control functions (e.g. 802.11 signaling and management functions (authentication, association etc), 802.1x authentication, administrative functions, logging, and the like) associated with the transfer of wireless (e.g. 802.11) data. Multiple application handlers 108 could be provided for separate control features, if desired.

In operation, then, data packets arriving at a network interface or other source are initially provided to classification handler 104, which assigns a classification to the packet and optionally forwards the packet to the appropriate protocol handler 106A-C and/or application handler 108A-C according to the classification. Inter-process communication and any interfacing to system hardware is provided using MCAL 102.

Turning now to FIG. 2, an exemplary implementation of a multi-core data processing system 200 suitably includes a control processor 201 in addition to one or more data handling processors 203A-C. Control processor 201 typically executes the base operating system (e.g. LINUX or the like), whereas the data handling processors 203A-C execute the various handler logic (e.g. classification handler 104, protocol handler 106, application handler 108 shown in FIG. 1). By dividing the data handling function from the operating system function, the overall throughput of system 200 can be markedly improved in many embodiments. The term “processor” as used in this context can refer to a physical processor, to a processing core of a multi-core processing chip, or to a so-called “virtual machine” running within a processor or processing core. That is, the MCAL 102 is created to adapt system 200 to available hardware so that the individual handler modules 104, 106, 108 need not be individually tailored to the particular hardware environment used to implement system 200. Similarly, any number of control and/or data handling processors 201, 203 could be used in a wide array of alternate embodiments.

Data handler modules 104/106/108 may be assigned to the various processors 201, 204 in any manner. In various embodiments, handler modules 104/106/108 are statically assigned to available hardware by pre-configuring the modules loaded at system startup or reset. Alternatively, modules 104/106/108 can be dynamically assigned to reduce any performance bottlenecks that may arise during operation. In such embodiments, MCAL 102 (or another portion of system 100) suitably assigns modules to available processing resources based upon available load. Load may be determined, for example, through periodic or aperiodic polling of the various processing cores 203, through observation of data throughput rates, and/or through any other manner. In various embodiments, MCAL 102 periodically polls each processing core to determine a then-current loading value, and then re-assigns over or under-utilized handler modules 104/106/108 in real time based upon the results of the polling. As noted above, MCAL 202 suitably includes any number of container structures 110A-C for facilitating inter-process communications between each of the various handler modules executing on the various and/or to otherwise abstract the multi-core hardware structure from particular software modules 104, 106, 108 (FIG. 1) as appropriate.

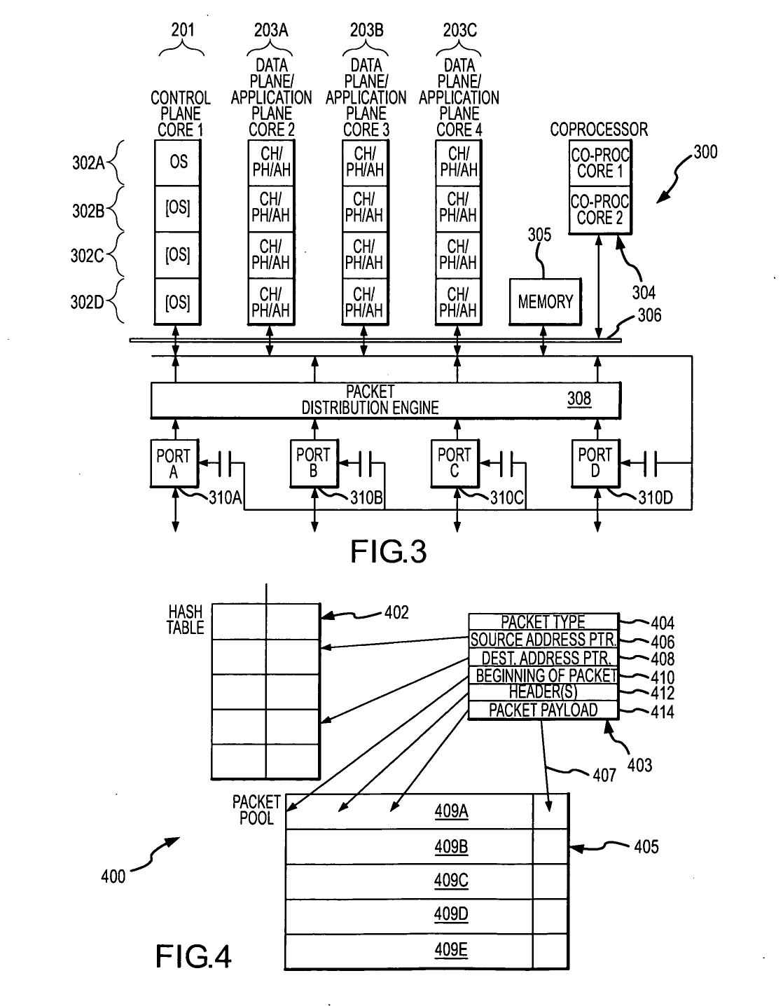

With reference now to FIG. 3, an exemplary data processing system 300 is shown in increasing detail. This system 300 suitably includes separate processors 201, 203A-C for control and data handling functions (respectively), with each processor 201, 203 executing any number of concurrent threads 302A-D as shown. System 300 also includes a digital memory 305 such as any sort of RAM, ROM or FLASH memory for storing data and instructions, in addition to any available mass storage device such as an sort of magnetic or optical storage medium. An optional coprocessor 304 may be provided to perform specialized tasks such as cryptographic functions, compression, authentication and/or the like. The various components of system 300 intercommunicate with each other via any sort of logical or physical bus 306 as appropriate.

In various embodiments, each control and data handling processor contains several “virtual” or logical machines 302A-D that are each capable of acting as a separate processor. In such cases, a software image containing data handlers 104/106/108 is executed within each active logical machine 302A-D as a separate thread that can be processed by data handler. Typically, each processing core 201, 203 includes its own “level 1” data and instruction cache that is available only to threads operating on that core. Memory 305, however, typically represents a memory subsystem that is shared between each of the processing cores 201, 203 found on a common chip. Memory 305 may also provide “level 2” cache that is readily accessible to all of the threads 302A-D running on each of the various processing cores 201, 203.

System 300 suitably includes one or more network interface ports 310A-D that receive data packets from a digital network via a network interface. The network interface may be any sort of network interface card (NIC) or the like, and various systems 300 may have several physical and/or logical interface ports 310A-D to accommodate significant traffic loads. As noted above, data handlers may be assigned to the various processing cores 203A-C and the various processing threads 302A-D using any sort of static or dynamic process.

In many embodiments, a packet distribution engine 308 is provided to initially distribute packets received via the network interface ports 310A-D to the appropriate classification handler 104. Packet distribution engine 308 is any hardware, software or other logic capable of initially providing access to data packets received from ports 310A-D. In various embodiments, packet distribution engine 308 may be implemented in an application specific integrated circuit (ASIC) for increased speed, for example, or the functionality could be readily combined with one or more classification handlers 104 using software or firmware logic. In either case, data packets arriving from network ports 310A-D are directed toward an appropriate classification handler 104 executing on one of the data handler processors 203A-C. This direction may take place in any manner; in various embodiments, each network port 310A-D has an associated classification handler 104 executing as a separate thread 302 on one of the data handling processors 203A-C. Alternatively, packets arriving at any port 310A-D are initially directed toward a common classification handler 104.

Classification, protocol and application handlers 104/106/108 are contained within a software image that is executed on each of the available data handling processors 203A-C, and operating system software is executed on the control plane 201. That is, the various data handlers 104/106/108 can be combined into a common software image so that each thread 302A-D on each processor 203A-C executes common software to provide the various data handling functions. This feature is optional, however, and not necessarily found in all embodiments.

As noted above, classification handlers 104 suitably classify and dispatch incoming data packets to an appropriate destination handler, such as a operating system thread on control processor 301 or a protocol or application handler on data handling processors 303A-C. Each protocol handler 106 typically runs a thread of a specific protocol supported by system 300 (e.g. 802.11 wireless, RFID, 802.16, any other wireless protocol, and/or any security protocols such as IPSec, TCP/IP or the like), and each application handler 108 runs an appropriate processing application to provide a feature such as location tracking, RFID identification, secure sockets layer (SSL) encryption and/or the like. As described above, protocol handlers 106 typically provide processing of actual data, whereas application handlers 108 typically provide control-type functionality. As noted above, MCAL 102 (FIGS. 1-2) assigns the various processors 201, 203 and threads 302 to each data handler 104/106/108 on a static, dynamic or other basis as appropriate. In single processor embodiments, MCAL 102 typically maps each handler to the same processor 201 that is running the operating system. MCAL 102 may physically reside within either processor 201, or any of processors 203A-C. Alternatively, the various functions performed by the MCAL 102 can be split across the various processors 201, 203 as appropriate.

In various further embodiments, a co-processor module 304 may also be provided. This module may be implemented with custom hardware, for example, to provide a particular computationally-intense feature such as cryptographic functions, data compression and/or the like. Co-processor module 304 may be addressed using the message send and receive capabilities of the MCAL 102 just as the various threads 302A-D executing on the multiple processing cores 301, 303A-C.

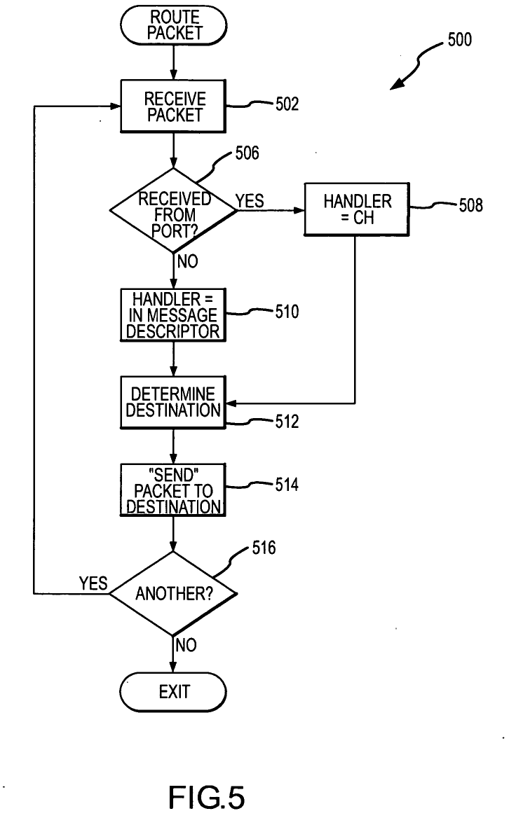

Referring to FIG. 4, an exemplary memory and addressing scheme 600 includes a pool 405 of memory space suitable for storing received data packets 409A-E, along with a packet descriptor 407 that contains a brief summary of relevant information about the data packet itself. This descriptor 407 may be created, for example, by a classification handler 104 (FIGS. 1-4), and includes such information as packet type 404, a pointer 406 to a source address, a pointer 408 to a destination address, a pointer 410 to the beginning of the packet, a copy 412 of any relevant message headers, and any relevant description 414 of the packet payload (e.g. the length of the payload in bytes). Various descriptors 407 may contain alternate information as appropriate. Source and destination address pointers 406, 408 may be obtained in any manner; in various embodiments, this information is obtained from a lookup table 402 or other appropriate data structure maintained within system memory 305. This information may be looked up in one handler (e.g. the classification handler), for example, and pointers to the relevant addresses may be maintained in the packet descriptor 407 to reduce or eliminate the need for subsequent lookups, thereby improving processing speed. With momentary reference again to FIG. 3, the data packet 409A-E and its associated data descriptor 407 can be maintained within system memory 305, where this information is readily accessible to each thread 302A-D executing on each processing core 301, 303A-C.

Turning now to FIG. 5, an exemplary generic process 500 for routing a data packet (e.g. packets 407A-E) through a data processing system (e.g. systems 100, 200, 300 described above) suitably includes the broad steps of receiving the data packet (step 502), determining an appropriate recipient handler (steps 506-510), and then “sending” the message to the destination handler (step 514). Process 500 is intended to illustrate the logical tasks performed by the data processing system; it is not intended as a literal software implementation. A practical implementation may arrange the various steps shown in FIG. 5 in any order, and/or may supplement or group the steps differently as appropriate. Nevertheless, process 500 does represent a logical technique for routing data packets that could be implemented using any type of digital computing hardware, and that could be stored in any type of digital storage medium, including any sort of RAM, ROM, FLASH memory, magnetic media, optical media and/or the like. The process outlined in FIG. 5 may be logically incorporated into the MCAL 102 best seen in FIGS. 1-2, for example, or may be otherwise implemented as appropriate.

As data packets are received at the message queue (step 502), the MCAL 102 first determines the appropriate handler to process the received message (step 506). In the event that the data packet is newly received from the network port (e.g. ports 310A-C in FIG. 3), then the handler is typically a classification handler 104 as described above (step 508). Otherwise, the destination handler can be determined from examination of the packet descriptor (see discussion of FIG. 4 above) contained within memory 305 (FIG. 3).

In various embodiments that maintain a common code image running in all threads, the classification handler 104, protocol handlers 106 and application handlers 108 are optionally invoked within the packet routing function 300 (step 512). In such embodiments, a switch-type data structure or the like identifies the destination as the classification handler 104, the appropriate protocol hander 106A-C for the particular protocol carried by the data packet, or the application handler 108A-C for the application type identified by the data packet. This feature is not required in all embodiments; to the contrary, step 512 may be omitted entirely in alternate but equivalent embodiments in which a common code image is not provided.

Upon determination of the appropriate destination for the data packet, the message is directed or “sent” (step 514) using any appropriate technique. The term “sent” is used colloquially here because the entire data packet need not be transported to the receiving module. To the contrary, a pointer to the packet or packet descriptor (see below) in memory 305 could be transmitted to the receiving module without transporting the packet itself, or any other indicia or pointer to the appropriate data could be equivalently provided.

Process 500 may be repeated as appropriate (step 516). In various embodiments, the “packet receive” feature is a blocking function provided by the MCAL 102 that holds execution of process 500 at step 502 (or another appropriate point) until a message is received in the message queue. As noted above, message queuing, as well as message send and receive features are typically provided within the MCAL 102 to make use of operating system and hardware-specific features.

Turning now to FIG. 6, an exemplary process 600 for classifying data packets (e.g. packets 407A-E in FIG. 4) suitably includes the broad steps of classifying the incoming packets (steps 602-618) and performing pre-processing by formatting and storing the packet as appropriate (step 622) to facilitate direction toward a particular protocol or application handler. Like process 500 above, process 600 is intended to illustrate various features carried out by an exemplary process, and is not intended as a literal software implementation. Nevertheless, process 600 may be stored in any digital storage media (such as those described above) and may be executed on any processing module 201, 203 as appropriate. Moreover, the exemplary process 600 shown in FIG. 6 illustrates multiple protocol implementation using the examples of wireless communication and RFID communication. Alternate embodiments could be built to support any number (e.g. one or more) protocols, without regard to whether the protocols are wired, wireless or otherwise.

Process 600 generally identifies packets as wireless (steps 602, 604, 606), RFID (steps 608, 610), application (steps 612, 614) or management/control (steps 616, 618, 620). These determinations are made based upon any appropriate factors, such as header information contained within the data packet itself, the source of the packet, the nature of the packet (e.g. packet size), and/or any other relevant factors. As the type of packet is identified, a classification is assigned to the packet (steps 606, 610, 614, 618, 620) to direct the packet toward its appropriate destination processing module. In the example of FIG. 6, packets that do not meet pre-determined classification criteria are sent to the operating system for further processing by default; alternate embodiments may discard the packet, forward the packet to another classification module 104, or take any other default action desired.

Classification process 600 also involves performing preprocessing (step 622) on the data packet. Pre-processing may involve creating and/or populating the data descriptor 407 for the packet described in conjunction with FIG. 4 above, and/or taking other steps as appropriate. In various embodiments, classification process 600 may include performing lookups to tables 402 (FIG. 4) to identify source, destination or other information about the packet. Although FIG. 6 shows step 622 as occurring only after the packet has been classified, in practice some or all of the data formatting, storing and/or gathering may equivalently take place prior to or concurrent with the classification process.

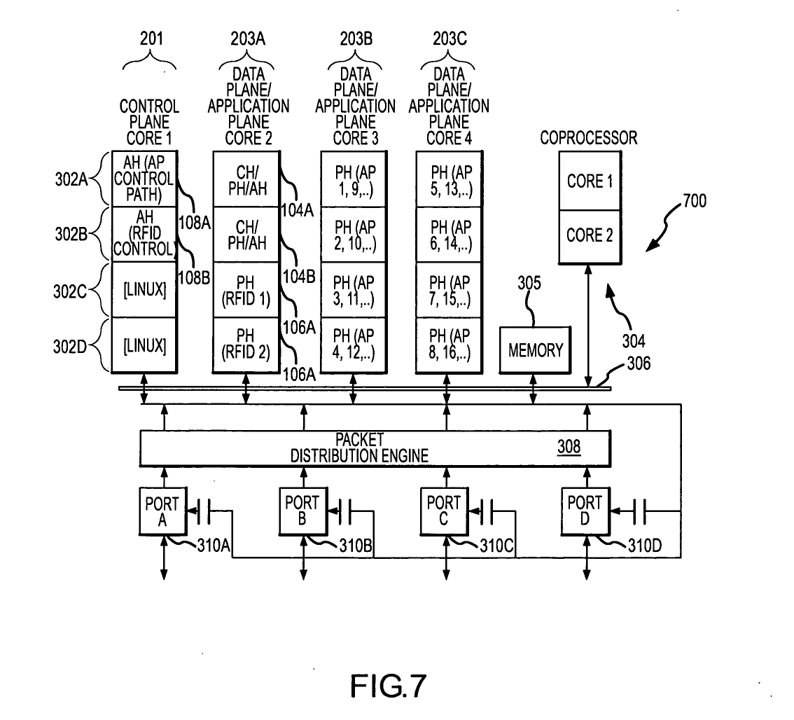

With final reference now to FIG. 7, an exemplary embodiment of a wireless switch 700 that is capable of directing 802.11 and RFID traffic is shown. Again, the combination of wireless and RFID protocols is intended merely as an example; in practice, device 700 may be any type of bridge, switch, router, gateway or the like capable of processing any number of protocols, and any type of wired or wireless protocols using any type of hardware and software resources. Further, alternate embodiments of the switch 700 could be readily formulated in many different ways; the particular data processing handlers 104/106/108, for example, could reside within any processing threads 302 executed by any of the data handling processors 203.

Wireless switch 700 suitably includes four processing cores 201 and 203A-C, with core 201 running the LINUX operating system in threads 302C-D of control core 201. Application handlers 108A-B providing control path handling for wireless access and RFID protocols, respectively, are shown executing within threads 302A-B of processing core 201, although alternate embodiments may move the application handlers 108A-B to available threads 302 on data handling cores 303A-C as appropriate. Threads 302A-B of processor 203A are shown assigned to classification handlers 104A-B, and threads 302C-D of processor 203A are shown assigned to protocol handlers 106A associated with RFID protocols. The remaining threads 302A-D on processing cores 303C-D are shown assigned to protocol handlers 106 for wireless communications, with each thread having assigned wireless access points (APs). Thread 302A of processor core 203B, for example, is assigned to process wireless data emanating from access points 1 and 9, whereas thread 302B of core 203B processes wireless data emanating from APs 2 and 10. Access points need not be assigned to particular protocol handlers 106 in this manner, but doing so may aid in load balancing, troubleshooting, logging and other functions.

In operation, then data packets arrive at wireless switch 700 via one or more network interface ports 310A-D from a local area or other digital network. These packets are initially directed toward a classification handler (e.g. handlers 104A-B on processing core 203A) by packet distribution engine 308. Alternatively, distribution engine 308 provides a portion of the classification function by storing the received packet in memory 305, and providing a pointer to the relevant packet to classification handler 104A or 104B. The classification handler 104, in turn, classifies the data packet as wireless, RFID, control or other data, and selects and appropriate protocol handler 106 or application handler 108 as appropriate. The relevant handler subsequently receives a pointer or other notification of the packet's location in memory 105, and processes the packet normally. Optionally, MCAL 102 monitors the loads on each processing core during operation, and re-assigns one or more handlers to keep loads on the various processing cores relatively balanced during operation.

As noted at the outset, the MCAL framework allows for efficient code design, since code can be designed to work within the framework, rather than being created for particular hardware platforms. Moreover, legacy code can be made to work with emerging hardware platforms by simply modifying the code to work within the abstraction constructs rather than addressing the hardware directly. Other embodiments may provide other benefits as well.

While at least one example embodiment has been presented in the foregoing detailed description, it should be appreciated that a vast number of equivalents exist. It should also be appreciated that the example embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention as set forth in the appended claims and the legal equivalents thereof.

What is claimed is:

1. A system for processing a data packet received at a network interface, the system comprising:
a classification handler configured to assign a classification to the data packet;
a plurality of protocol handlers each associated with one of a plurality of data protocols and configured to process the data packet if the classification of the data packet matches the data protocol associated with the protocol handler;
a plurality of application handlers each associated with one of a plurality of user applications, wherein each application handler is configured to process the data packet if the classification of the data packet matches the user application associated with the application handler; and
a multicore abstraction layer (MCAL) in communication with the classification handler, each of the plurality of protocol handlers, each of the application handlers and the network interface, and wherein the MCAL is configured to send the data packet to the classification handler after the packet is received at the network interface, and to subsequently direct the packet toward one of the plurality of protocol handlers or one of the plurality of application handlers in response to the classification of the data packet.

2. The system of claim 1 further comprising an operating system and wherein the MCAL is configured to provide an interface between the classification handler, the plurality of protocol handlers, and the plurality of application handlers to the operating system.

3. The system of claim 2 wherein the MCAL, classification handler and plurality of protocol handlers reside in kernel space of the operating system.

4. The system of claim 3 wherein the plurality of application handlers reside in user space of the operation system.

5. The system of claim 1 wherein the MCAL, classification handler, plurality of protocol handlers and plurality of application handlers co-exist within a common memory space.

6. The system of claim 2 wherein the system is configured to execute on a processor comprising a plurality of processing cores and wherein the MCAL is further configured to provide an interface to the plurality of processing cores for the classification handler, plurality of protocol handlers and plurality of application handlers.

7. The system of claim 6 wherein the operating system is executed on a first one of the plurality of processing cores and wherein the classification handler, plurality of protocol handlers and plurality of application handlers execute on separate processing cores from the operating system.

8. The system of claim 6 wherein each of the processing cores are configured to execute a plurality of threads, each of the threads corresponding to one of the classification handler, the plurality of protocol handlers and the plurality of application handlers.

9. The system of claim 6 wherein the MCAL is further configured to manage assignment of system resources to each of the classification handler, the plurality of protocol handlers and the plurality of application handlers.

10. The system of claim 6 wherein the MCAL is further configured to collect data regarding traffic load on each of the plurality of processing cores and to perform load balancing by moving at least one of the classification handler, plurality of protocol handlers and plurality of application handlers from a first one of the plurality of processing cores to a second one of the plurality of processing cores that has a lower traffic load than the first one of the plurality of processing cores.

11. The system of claim 1 further comprising a digital memory configured to store the contents of the data packet.

12. The system of claim 11 wherein the digital memory is further configured to store a packet descriptor in conjunction with the data packet, and wherein the packet descriptor comprises a source and a destination address.

13. The system of claim 11 wherein the MCAL is further configured to direct the data packet by sending a pointer to the packet descriptor of the data packet in the memory.

14. The system of claim 1 further comprising a coprocessing engine, and wherein the MCAL is further configured to direct the data packet toward the coprocessing engine.

15. The system of claim 1 wherein the classification handler comprises a packet distribution engine.

16. A method of processing a data packet within a computing system having a network interface, the method comprising the steps of:
receiving the data packet at the network interface;
initially directing the data packet toward a classification handler executing on the computing system;
classifying the data packet at the classification handler;
directing the data packet toward one of a protocol handler or an application handler executing on the computing system based upon the results of the classifying step; and
processing the data packet at the one of the protocol handler or the application handler executing on the computing system.

17. The method of claim 16 wherein the directing steps comprise passing a pointer to a data structure stored in a memory.

18. The method of claim 17 wherein the passing step is performed on a first processing core and the processing step is performed on a second processing core separate from the first processing core.

19. The method of claim 16 wherein the classifying step comprises determining if the data packet is a control packet.

20. The method of claim 16 wherein the classifying step comprises determining which of a plurality of protocols corresponds to the data packet.

21. The method of claim 16 wherein the classifying step comprises formatting the data packet in memory with a packet descriptor, and wherein subsequent directing of the data packet comprises passing a pointer to the packet descriptor.

22. A digital storage medium configured to store computer-executable instructions configured to execute the method of claim 16.

23. A system for processing a data packet received at a network interface with a plurality of processing cores, each processing core configured for executing a plurality of distinct processing threads, the system comprising:
an operating system executing on a first one of the plurality of processing cores;
a classification handler executing in a first one of the plurality of processing threads on one of the processing cores other than the first processing core, wherein the classification handler is configured to assign a classification to the data packet;
a plurality of protocol handlers each executing in separate processing threads on processing cores other than the first processing core, wherein each of the plurality of protocol handlers is associated with one of a plurality of data protocols and is configured to process the data packet if the classification of the data packet matches the data protocol associated with the protocol handler;
a plurality of application handlers each executing in separate processing threads on processing cores other than the first processing core, wherein each application handler is associated with one of a plurality of user applications, wherein each application handler is configured to process the data packet if the classification of the data packet matches the user application associated with the application handler; and
an multicore abstraction layer (MCAL) in communication with the classification handler, each of the plurality of protocol handlers, each of the application handlers and the network interface, and wherein the MCAL is configured to interface with the operating system to send the data packet to the classification handler after the packet is received at the network interface, and to subsequently direct the packet toward one of the plurality of protocol handlers or one of the plurality of application handlers in response to the classification of the data packet.

24. The system of claim 23 wherein the system further comprises a digital memory in communication with each of the plurality of processing cores and configured to stored the data packet in conjunction with a packet descriptor, and wherein the MCAL is further configured to direct the packet toward the one of the protocol or application handlers by passing a pointer to the packet descriptor.
